(19) United States
(12) Patent Application Publication
(10) Pub. No.: US 2017/0234024 A1
(43) Pub. Date: Aug. 17, 2017

(54) A Support Structure

(71) Applicant: Frank J Hardie, Bedford, Bedfordshire (GB)

(72) Inventor: Frank J Hardie, Bedford, Bedfordshire (GB)

(21) Appl. No.: 15/505,921

(22) PCT Filed: Dec. 5, 2014
(86) PCT No.: PCT/GB2014/053619

§ 371 Date: Feb. 22, 2017

(30) Foreign Application Priority Data
Dec. 6, 2013 (GB) 1321630.4

(51) Int. Cl. E04H 12/22; F21V 21/10; E04H 12/34; F21S 8/08

(52) U.S. Cl. CPC E04H 12/2276; F21S 8/086; F21V 21/10; E04H 12/345

(57) ABSTRACT

Disclosed herein is an adaptor for connecting a new post structure for supporting an electrical device to an existing post structure for supporting an electrical device, the adaptor comprising one or more first engaging features arranged, in use, to engage with at least part of the existing post structure, and one or more second engaging features arranged, in use, to engage with at least part of the new post structure. Also disclosed is a connection structure for forming part of a post structure for supporting an electrical device. In addition, a lamp unit forming part of a street lamp is disclosed.

### FIELD

A support structure is disclosed herein. More specifically, but not exclusively, a new support structure for mounting over an existing lamp post is disclosed. In addition, a support structure for mounting a lighting element is disclosed.

### BACKGROUND

From time to time, street lamps may require replacement. This may be for any of a number of reasons. For example, a street lamp may be replaced because it is damaged, because its lamp is not bright enough, because the light pattern cast by the lamp is not suitable for the area surrounding the lamp, because the height of the lantern above the street needs to be changed, because the old light is no longer aesthetically pleasing, or because improvements in street lighting technology mean that the old lamp is no longer the most energy-efficient or safe method of lighting a street.

Currently, when a street lamp is to be replaced, a second lamp is first installed adjacent to the street lamp to be replaced. This requires digging a hole for the replacement street lamp. The replacement street lamp, which can be very long—up to 8 metres is common—is then brought to the site where it is to be installed. A crane is then used to install the street lamp in the hole which has been dug for it. This hole needs to be filled so that the street lamp stands securely. Next, electrical cabling from the existing street lamp (which is to be replaced) is run from the existing street lamp to the replacement street lamp. This step often requires a separate team than the team which installed the replacement lamp. Finally, the existing lamp is removed, again using a crane, and the hole where it stood is filled in. Typically, this process can take up to 28 days. It can be disruptive to pedestrians and traffic around the location of the existing street lamp and its replacement. It is also costly.

### SUMMARY

This disclosure attempts, at least in part, to address at least some of these problems with existing street lamp lanterns and methods of replacement.

According to a first aspect of the invention, there is provided an adaptor for connecting a new post structure for supporting an electrical device to an existing post structure for supporting an electrical device, the adaptor comprising: one or more first engaging features arranged, in use, to engage with at least part of the existing post structure; and one or more second engaging features arranged, in use, to engage with at least part of the new post structure.

The adaptor therefore allows for a generally faster, more efficient, and less expensive way of replacing existing street lamps.

At least one of the one or more first and second engaging features may be surfaces of the adaptor. At least one of the one or more first and second engaging features are formed on surfaces of the adaptor. The one or more first engaging features may form at least part of an interior surface of the adaptor. The one or more second engaging features may form at least part of an exterior surface of the adaptor. The one or more first engaging features may define an interior cross-section of the adaptor. The interior cross-section of the adaptor may be arranged to match the exterior cross-section of the existing post structure. The one or more second engaging features may be arranged to connect to complementary engaging features of the new post structure. The one or more second engaging features may be longitudinal indentations. The longitudinal indentations may be arranged to engage with longitudinal protrusions on an interior surface of the new post structure.

The adaptor may comprise a stopper arranged such that, in use, when the adaptor is fitted to the old post structure, the adaptor sits on the top of the old post structure with the stopper preventing the adaptor moving down the old post structure.

The adaptor may define an axial hole through which electrical cables are able to pass.

The adaptor may be made of high-density foam.

The adaptor may comprise a plurality of alternative one or more first engaging features. The alternative one or more first engaging features may each be arranged for connecting to a different type of existing post structure. A first of the plurality of alternative one or more first engaging features may be removably connectable to a second of the one or more first engaging features such that, in use, when the first of the one or more first engaging features is connected to the second of the one or more first engaging features the adaptor is arranged to connect to the existing post structure via the first engaging features. A first of the plurality of alternative one or more first engaging features may be removably connectable to a second of the one or more first engaging features such that when the first of the one or more first engaging features is not connected to the second of the one or more first engaging features the adaptor is arranged to connect to the existing post structure via the second of the one or more first engaging features.

The existing and new post structures may be lamp post structures.

According to a second aspect of the invention, there is provided a lamp post comprising an adaptor according to the first aspect.

Optional features of the first aspect are also optional features of the second aspect.

According to a third aspect of the invention, there is provided a connection structure for forming part of a post structure for supporting an electrical device, the connection structure comprising: a first connector arranged to connect to a base portion of a post structure; and a second connector arranged to connect to a supporting shaft of the post structure for supporting an electrical device, the second connector providing for a hinged connection between the connection structure and the supporting shaft, the hinged connection defining an axis of rotation; wherein the connection structure is arranged to provide a plurality of different positional relationships between the position of the base portion and the position of the axis of rotation of the hinged connection.

The first connector may be arranged to connect to a base portion of a post structure having an opening for accessing electrical components inside the existing post structure. The connection structure may be arranged to provide a plurality of different positional relationships between the position of the opening in the base portion and the position of the axis of rotation of the hinged connection

The second connector may provide a finite number of positions for the base structure to connect. The finite number of positions may be defined by a number of teeth.

The first and second connectors may be formed of one piece.

The connection structure may further comprise a connection element for connecting the first and second connectors.

The connection structure may further comprise a third connector arranged to connect the post structure to an existing post structure. The third connector may be the adaptor of the first aspect.

According to a fourth aspect of the invention, there is provided a lamp post comprising the connection structure of the third aspect.

Optional features of the third aspect are also optional features of the fourth aspect.

According to a fifth aspect of the invention, there is provided a lamp unit for forming part of a street lamp, the lamp unit comprising: a lighting device mount comprising a plurality of lighting device support elements each arranged for supporting at least one lighting device, at least one of the lighting device support elements being arranged at an angle relative to at least another one of the lighting device support elements to define, in use, a light pattern produced by the lighting devices; and an enclosure for enclosing the lighting device mount.

The plurality of lighting device support elements may comprise a first lighting device support element and a second lighting device support element. The second lighting device support element may be arranged perpendicular to the first lighting device support element such that the first and second lighting device support elements face away from one another to provide a wide light pattern in use. The first and second lighting device support elements may be arranged at 45 degrees to the horizontal when the lamp unit is arranged substantially horizontally. A third lighting device support element may be formed at a point at which the planes on which the first and second lighting device elements are mounted converge. The lighting device support elements may run along the length of the lighting device mount.

The lighting device mount may be arranged to support a solar panel. The lighting device mount may be arranged to support a solar panel on an opposite side to a side on which the plurality of lighting device support elements are formed.

The lamp unit may further comprise a support device for mounting of the lamp unit. The enclosure may be arranged to be connected to the support device. The enclosure may have at least a portion for light to pass through.

The enclosure may enclose the lighting-device mount except where the lighting-device mount connects to the support device. The enclosure may be formed with two open ends. The enclosure may be connected to the support device at a first open end and the lamp unit further comprises an end-connector connected to a second open end of the enclosure. The enclosure may encapsulate the lighting device mount along its length.

The enclosure may be cylindrical. The enclosure may be made from a transparent material. The enclosure may be made from a translucent material.

The lighting-device mount may have substantially the same cross-section along its length.

According to a fifth aspect of the invention, there is provided a lamp unit for forming part of a street lamp, the lamp unit comprising: a support device for mounting of the lamp unit; a lighting device mount connected to the support device, the lighting device mount arranged to support at least one lighting device, in use; and an enclosure for housing the lighting device mount, the enclosure connected to the support device and having at least a portion for light to pass through.

The enclosure may enclose the lighting device mount except where the lighting device mount connects to the support device. The enclosure may be formed with two open ends. The enclosure may be connected to the support device at a first open end. The lamp unit may further comprise an end-connector. The end-connector may be connected to a second open end of the enclosure. The enclosure may encapsulate the lighting device mount along its length. The enclosure may be cylindrical. The enclosure may be made from a transparent or translucent material.

The lighting device mount may have substantially the same cross-section along its length. The lighting device mount may be arranged to support a solar panel. The lighting device mount may be arranged to support a solar panel on an opposite side to a side on which the lighting device support is arranged to support at least one lighting device.

According to a sixth aspect of the invention, there is provided a lamp post comprising a lamp unit according the fifth aspect.

The following options may be combined with any aspect disclosed herein.

Also disclosed is an adaptor for connecting an existing lamp post structure to a new lamp post structure, the adaptor arranged to adapt at least part of a base, which may also be referred to herein as an “existing post structure”, for connection to a sleeve, which may also be referred to herein as a “new post structure” or may form part of what is referred to as a “new post structure”, the sleeve arranged to support a first structure, wherein the adaptor comprises a first, interior, surface arranged to engage with at least part of an exterior surface of the base, and a second, exterior, surface arranged to engage with at least part of an interior surface of the sleeve.

The base may be a first lamp post structure. The base may be a part of a first lamp post. The base may be the lower part of a first lamp post. The base may be a base section of a first lamp post. The part of the first lamp post may comprise at least one electrical connection arranged to transmit electrical current. The part of the first lamp post may comprise at least one door.

The sleeve may be a tube. The sleeve may have substantially the same cross section along its length. The sleeve may be arranged to have a minimum interior diameter greater than a maximum diameter of the base. The sleeve may be arranged to fit around the base. The sleeve may have an interior surface, and an exterior surface. The interior surface may comprise longitudinal protrusions. The longitudinal protrusions may be arranged to align with longitudinal indentations in an exterior surface of the adaptor. The sleeve may comprise at least one door. The door may be arranged to align with at least one door in the base.

The first structure may be a structure arranged to support at least one lantern. The first structure may be a structure arranged to support at least one camera. The first structure may be a lamp post structure.

The adaptor for connecting an existing lamp post structure to a new lamp post structure allows a sleeve to be fitted to cover an existing lamp post, and a new lamp post to be supported by this sleeve. When the existing lamp post comprises an electrical connection arranged to transmit electrical current, this electrical connection can be used to transmit power to a lamp mounted on the new lamp post. The adaptor allows an existing lamp post base to be used as a support and/or as a source of electrical power for a replacement lamp.

The adaptor may be a tube. The adaptor may be a tube, capped at one end. The adaptor may comprise a tube section and a cap section. The cap section may define an axial hole. The first, interior, surface may have substantially the same cross-section as a cross-section of an exterior surface of the base. The first surface may be octagonal in cross section. The first surface may be substantially square in cross section. The first surface may be substantially circular in cross section. The first surface may have conceivably any cross-section which allows the adaptor to fit a base of a defined cross-section. The second, exterior, surface may have substantially the same cross-section as a cross-section of an interior surface of the sleeve. The second surface may define longitudinal indentations. The longitudinal indentations may be arranged to align with longitudinal protrusions in an interior surface of the sleeve. The adaptor may be arranged to define a cavity. The adaptor may be arranged to define a cavity for engaging at least part of the base. The cavity may be arranged to engage an end of the base.

When the interior surface has substantially the same cross-section as a cross-section of an exterior surface of the base, the adaptor can fit snugly around the base. When the adaptor comprises a tube section and a cap section, the adaptor may be secured on the end of a base. The cap prevents it from slipping down the base. When a cap section of the adaptor defines an axial hole, and the base comprises an electrical connection arranged to transmit electrical current, cabling from this electrical connection can be run through the hole. This allows the base to be used as a source of electrical power for a replacement lamp mounted on the structure.

The adaptor may be of foam. The adaptor may be of high density foam. The adaptor may be of polystyrene.

Also disclosed is a connector, which may also be referred to as a “connection structure” or form part of what may be referred to as a “connection structure”, for connecting a new lamp post structure to an existing lamp post structure, the connector arranged to connect a first structure to a sleeve and the sleeve arranged to encase a base, wherein the connector comprises a hinge structure arranged to couple the connector to the first structure and a mating structure arranged to mate the connector to the sleeve.

The mating structure may be arranged to mate the connector to the sleeve in any one of a finite number of defined positions relative to the sleeve. The mating structure may comprise indentations arranged to mate with protrusions on an interior surface of the sleeve. The mating structure may comprise protrusions arranged to mate with indentations on an interior surface of the sleeve. The mating structure may be arranged to mate the connector to the sleeve via an adaptor according to the first aspect. The connector may be arranged to engage at least a part of the sleeve and at least a part of the adaptor according to the first aspect. The connector may be arranged to be coupled to the sleeve in any one of eight positions relative to the sleeve.

The connector may be of aluminium. The connector may be of aluminium alloy. The connector may be of steel.

When the connector is arranged to be coupled to the sleeve in one of a finite number of defined positions relative to the sleeve, the orientation of the hinge structure relative to the sleeve can be selected. When the first structure coupled to the hinge structure is a lamp post, this feature allows the hinging direction of the lamp post relative to the sleeve to be selected. When the lamp post is close to a wall, for example, this feature allows the lamp post to be hinged away from the wall. In certain arrangements, the orientation of the sleeve will be determined by the position of a door in the base structure. Despite this, this feature nevertheless allows the hinge direction of the lamp post to be determined.

Also disclosed is a lighting device mount, the mount arranged to support a plurality of lighting devices, at least one of the lighting devices at an angle relative to at least another one of the lighting devices such that a light pattern produced by the lighting devices in use is determined by the configuration of the mount.

The mount may define a plurality of supports, also referred to herein as “lighting device support elements”. The supports may lie in parallel and intersecting planes. The supports may lie in different planes. The supports may be grooves. The mount may define grooves along its length.

The lighting device mount may have substantially the same cross-section along its length. The lighting device mount may be formed by extrusion. The lighting device mount may be of aluminium or an aluminium alloy. The lighting-device mount may be of extruded aluminium or aluminium alloy.

When the lighting device mount has substantially the same cross-section along its length, it can readily be manufactured by an extrusion process. Different lengths of lighting device mount can also easily be manufactured, without different tooling, since the mount can simply be cut to a desired length. A longer lighting device mount can be used to support a greater number of lighting devices, creating a different light pattern than a shorter lighting device mount.

The lighting device mount may be arranged to support an array of LEDs arranged on a substrate. The mount may be arranged to support an array of LEDs arranged on a strip of substrate. When the supports are grooves, each groove may be arranged to hold at least one strip of LEDs. The lighting device mount may be arranged to support a plurality of spotlights. The lighting device mount may be arranged to support any other suitable light.

When the supports are grooves and the lighting-device mount is arranged to support an array of LEDs arranged on a strip of substrate, a strip of LEDs can be slid along a groove in the lighting-device mount, which then supports that strip. Similarly, the strip of LEDs can be removed by sliding it out of the groove in the lighting-device mount. The grooves therefore allow easy installation and removal of lighting devices in the lighting-device mount.

Also disclosed is a lamp, also referred to herein as a “lamp unit”, comprising the lighting device mount.

The lamp may be hermetically sealed. In embodiments where the lamp is hermetically sealed, the lamp casing protects the lighting devices from moisture. In such embodiments, the reduced moisture within the lamp casing reduces condensation on the lamp casing interior. This increases the luminosity provided by the lamp when the lighting devices are in operation. The lamp may be filled with a gas other than air. The lamp may be filled with argon. In embodiments where the lamp casing is filled with argon, and where the lighting devices are LEDs, the LEDs operate at a lower temperature than if the lamp casing were filled with air. This can increase the lifetime of the LEDs. In turn, this reduces the frequency with which repairs to the lamp must be undertaken.

Also disclosed is a lamp fitting for forming part of a street lamp, the lamp fitting comprising: an enclosure for housing at least one lighting device, the enclosure mounted at a first end to a support device and having at least a transparent portion for transmitting light; and an end-connector connected to a second end of the enclosure.

The enclosure may be of glass. The enclosure may be of plastic. The enclosure may be of self-cleaning plastic. The enclosure may be substantially a hollow cylinder in shape. The enclosure casing may be substantially circular in cross-section. The enclosure may have substantially the same cross-section along its length.

When the enclosure has substantially the same cross-section along its length, different lengths of enclosure can be manufactured without different tooling. The enclosure can simply be cut to the desired length.

The lamp may comprise at least one photo voltaic cell. When the lamp fitting comprises a lighting device mount, the at least one photo voltaic cell may be arranged on a first surface of the lighting device mount.

Also disclosed is an adaptor arranged to adapt at least part of a support post for connection to a sleeve post, the sleeve post arranged to support a lamp post.

Also disclosed is a connector for connecting a sleeve post to a main post, wherein the connector comprises a hinge portion for coupling to the main post, and the connector is arranged to be coupled to the sleeve post in any one of a finite number of positions relative to the sleeve post.

Also disclosed is an end-connector for a lamp, the end-connector arranged to be connected to a first end of a lamp casing and to a first end of a lighting-device mount.

Optional features may be combined.

### BRIEF DESCRIPTION OF THE DRAWINGS

Specific embodiments of the invention are described below by way of example only and with reference to the accompanying drawings, in which:

FIG. 1 shows an existing lamp post;

FIG. 2 shows an adaptor in the form of a foam cap;

FIG. 3 shows an exploded view of components connecting a new lamp post to an existing post structure in the form of a lamp post base;

FIG. 4 shows the adaptor connected to the lamp post base;

FIG. 5 shows a cross-sectional view of a new post structure in the form of a tubular over-sleeve;

FIGS. 6a and 6b each show a different view of a first connector in the form of a toothed disc;

FIG. 7 shows the toothed disc connecting the over-sleeve to the lamp post base;

FIG. 8 shows a second connector in the form of a hinged support for the new lamp post;

FIGS. 9a and 9b each show a view of a cover in the form of a conical lid;

FIG. 10 shows the components connecting the new lamp post to the lamp post base when assembled;

FIG. 11 illustrates how the new lamp post is hinged relative to the lamp post base;

FIG. 12 shows a lamp unit in the form of a lantern;

FIG. 13 shows a lighting-device mount, or “mount”;

FIG. 14 shows a cross-sectional view of the mount;

FIGS. 15a and 15b show a support device in the form of a socket;

FIG. 16 shows a lamp post fitting;

FIG. 17 shows a ratchet;

FIG. 18 shows an end-connector in the form of an end-cap;

FIGS. 19a, 19b and 19c show different views of a gasket; and

FIG. 20 shows a sectional view of the lantern, the section taken along its axis.

### SPECIFIC DESCRIPTION OF CERTAIN EXAMPLE EMBODIMENTS

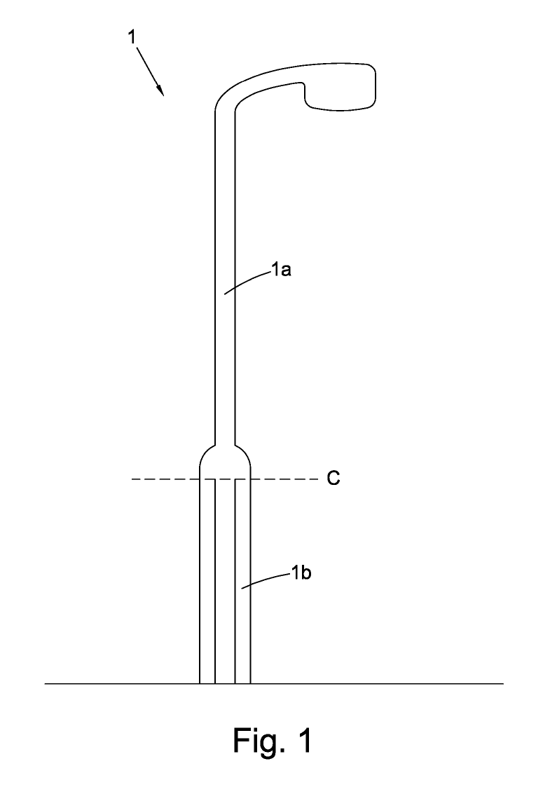

As discussed above, a faster, more efficient, and less expensive way of replacing existing street lamps is disclosed herein. In this exemplary embodiment a system is proposed which allows for a new improved lamp post to be mounted over and onto an existing lamp post. FIG. 1 shows an existing lamp post 1, which is due to be replaced. In the process of replacing the lamp post 1 with a new lamp post, the first step is to cut off the main pole and light fitting 1a of the lamp post 1 just above the base 1b of the lamp post 1 shown by the dashed line C in FIG. 1.

The new replacement lamp post, which has a larger internal diameter than the external diameter of the base 1b of the existing lamp post 1 is then simply placed over the existing lamp post.

In order to connect the new lamp post structure to the existing lamp post structure an adaptor is provided. Specifically, the adaptor can be fitted to the base section 1b of the existing lamp post 1 to allow a sleeve-like base of the new lamp post to be fitted over it. The external surface of the base 1b of the existing lamp post 1 has an octagonal cross-section, whereas the new lamp has a circular external cross section. The adaptor therefore acts as an interface between the two different lamp post structures holding the new lamp post in position with respect to old lamp post. Once the adaptor is fitted to the base 1b of the existing lamp post 1, the new post can then be fitted over the adaptor

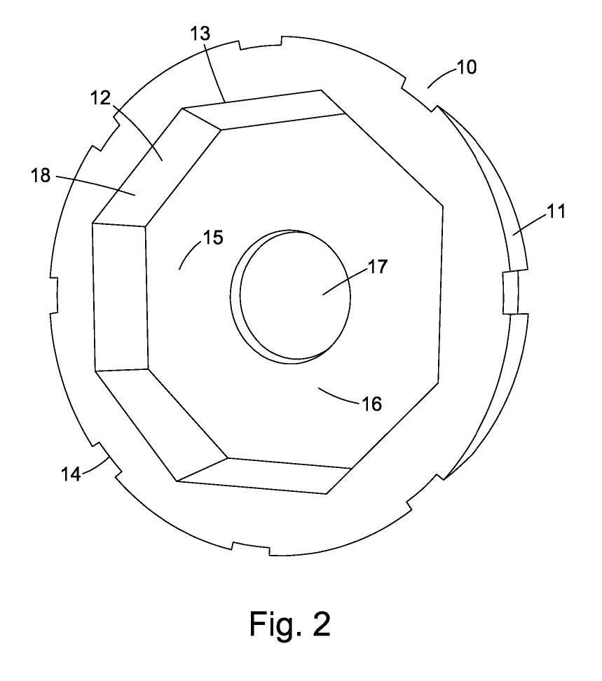

With reference to FIG. 2, the structure of this adaptor will now be described. FIG. 2 shows an adaptor. In this embodiment, the adaptor is a cap 10 configured to be placed on the top of the base 1b of the existing lamp post 1. The cap 10 has a flat upper surface, or top, 15. The top 15 of the cap 10 acts as a stopper so that the cap cannot be pushed down the octagonal shaft of the existing lamp post 1. As such, the cap 10 remains fixed to the top of the base 1b of the existing lamp post 1. A wall 18 extends around the circumference of the top 15. The wall 18 is roughly perpendicular to the top 15. In other words, the cap 10 is generally shaped like a section of a cylinder, closed at one end by the top 15. The wall 18 has an outer surface 11 and an inner surface 12. In cross section, the inner surface 12 in this embodiment is octagonal in cross-section so that it can engage with the outer octagonal surface of the base 1b of the existing lamp post. The inner surface 12 has eight facets 13, forming the sides of the octagon. Each facet 13 arranged to engage with a respective outer facet of the base 1b of the existing lamp post. The outer surface 11 is substantially circular. The wall 18 is therefore not of constant width radially. The inner surface 12 of the wall 18, along with the top 15, define a cavity 16.

The outer surface 11 has eight grooves 14, or indentations, along its length (i.e. perpendicular to the top 15). These grooves 14, are evenly radially spaced around the outer surface 11 of the wall 18. The grooves 14 are at positions on the outer surface 11 of the wall corresponding to the centre of each facet 13 of the inner surface 12 of the wall 18 when measured radially. These grooves 14 are arranged to engage with complementary portions of the new lamp post, as will be described in due course. The cap 10 is formed of high-density polystyrene foam. It is formed by casting in a mould.

The cap 10 may alternatively be formed by being cut from a sheet of high-density foam. This alternative cap 10 has cuts in it which, when sections of foam are removed (for example by being pushed out), form the inner surface 12 of the wall 18. This arrangement allows for the inner surface 12 of the wall 18 to have different cross-sections depending on which sections of foam are removed. The foam sheet can have cuts in it which allow sections to be removed to create an inner surface 12 which is octagonal in cross-section, as described above, and cuts in it which allow different sections to be removed to create an inner surface 12 which is circular in cross-section, for example. A single piece of foam may thus be used to create caps 10 of differing configurations.

The cap 10 is therefore arranged to sit on the top of the base 1b of the existing lamp post 1 and have at least one inner engaging element, formed in this exemplary embodiment by the eight facets 13, arranged to connect with the existing lamp post 1, and at least one outer engaging element, in this case formed by the grooves 14, arranged to connect to the new lamp post.

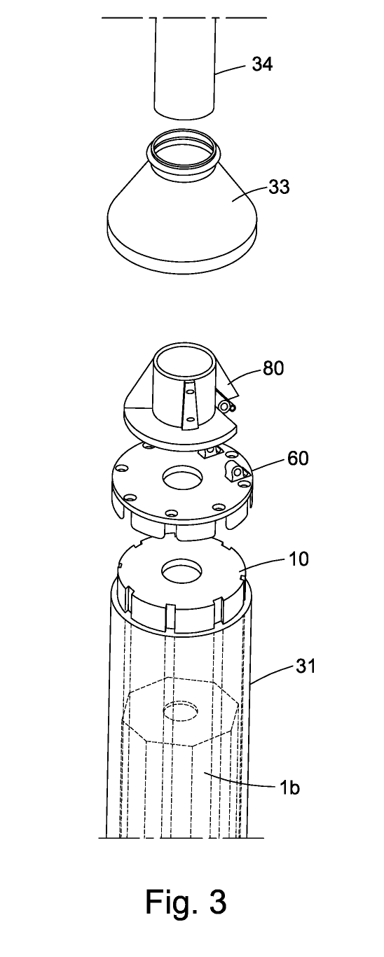

In adapting the base section of an existing lamp post to allow a new lamp post effectively taking the form of a sleeve to be fitted over it, the cap 10 is used with a number of other components. An overview of the other components with which it is used will now be given with reference to FIG. 3. As well as showing the cap 10, FIG. 3 also shows: the base 1b of the existing lamp post base 1; a sleeve in the form of a tubular over-sleeve 31, which forms the base of the new lamp post and is arranged to substantially surround the main shaft of the base 1b of the existing lamp post; a connector in the form of a toothed disc 60 arranged to connect to the cap 10 and the over-sleeve; a structure in the form of a new upper lamp post 34 that is arranged to connect to a hinged support in the form of a bracket 80, the hinged support also arranged to connect to the connector 60 and allow for the upper lamp post 34 to be lowered with respect to the fixed base via the hinge for maintenance and such like; and also provided is a cover 33 for covering at least the hinged support 80 and connector 60 when the new upper lamp post 34 is in a fixed upright position. These are all described in more detail below.

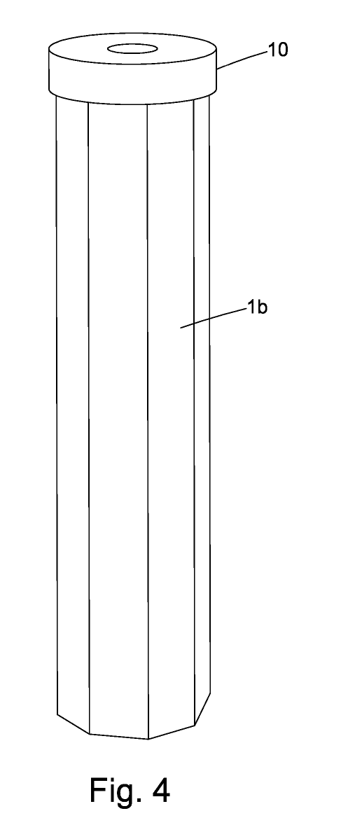

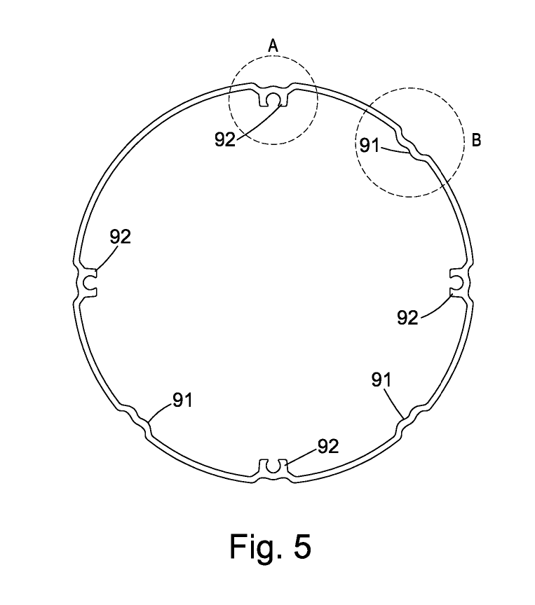

First, the lamp post base 1b will be described with reference to FIG. 4. FIG. 4 shows the base 1b of the existing lamp post 1. The base is the part of the existing lamp post which is rooted in the ground and which contains the electronics for that lamp post. The lamp post base 1b is what is left of a street lamp when the lamp post has been cut off above a door (not shown) which gives access to the lamp post electronics. As has already been mentioned in respect of FIG. 2, the lamp post base 1b is octagonal in cross section. This is common in concrete lamp posts. FIG. 2 also shows the cap 10 which has just been described. As mentioned above, the inner surface 12 of the cap 10 wall 18 is also octagonal in cross section. The diameter of the cavity 16 formed by the wall 18 of the cap 10 is the same, or just larger than, the diameter of the lamp post base 1b. This means that the cap 10 can be fitted to the top of the lamp post base 1b. Each facet 13 of the inner surface 12 of the wall 18 of the cap 10 corresponds to a facet of the octagonally-cross-sectioned lamp post base 1b. In FIG. 4 it can be seen that the cap 10 is placed over the top end of the lamp post base 1b. Since both the cavity 16, formed by the wall 18 of the cap 10, and the lamp post base 1b are octagonal in cross section, and since their diameters are the same, the cap 10 fits the lamp post base snugly. When assembled, the top 15 of the cap 10 sits on top of the lamp post base 1b (where it has been cut off). This prevents the cap 10 from slipping down the lamp post base 1b. Next, the sleeve in the form of a tubular over-sleeve 31 will be described with reference to FIG. 5. FIG. 5 shows the tubular over-sleeve 31 in cross-section. The over-sleeve 31 forms the base of the new lamp post formed over the existing lamp post. The tubular over-sleeve 31 is a tube formed of extruded aluminium. As can be seen from FIG. 5, the tubular over-sleeve 31 has three longitudinal protrusions 91 running along the length of the interior of the over-sleeve. Two of these protrusions 91 are radially opposite one another, and the third protrusion 91 is radially half-way between these two, Typically the over sleeve 31 includes a door (not shown). The door is configured in such a way that allows for access to be obtained to the door of the base 1b of the existing lamp post. As such, maintenance personnel are able to access the electronics inside the existing lamp post through both the over-sleeve and the base 1b of the existing lamp post.

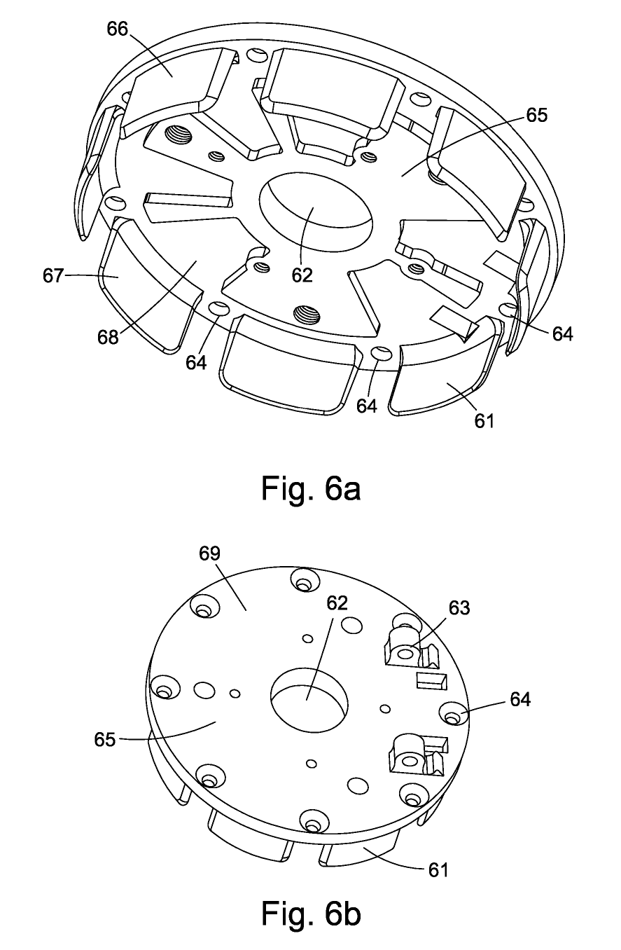

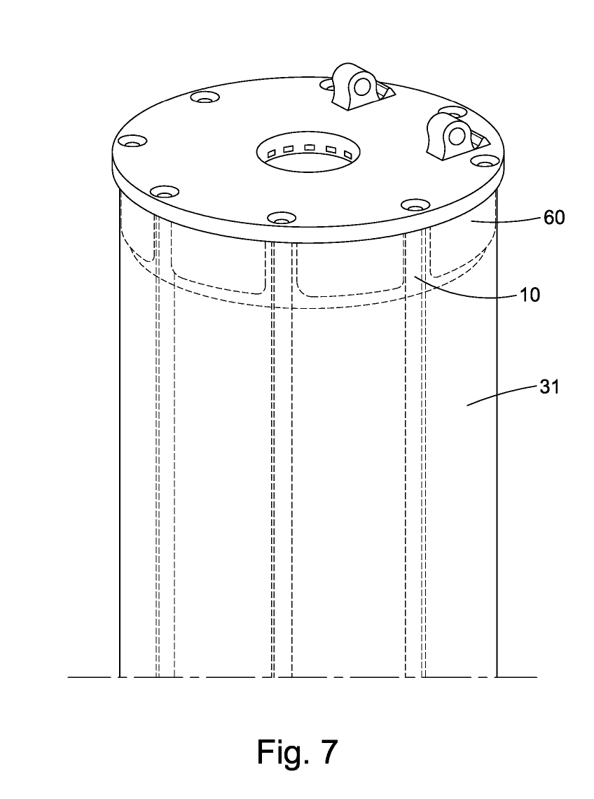

With reference now to FIG. 6a which shows a perspective view of an underside of the toothed disc 60, the connector in the form of a toothed disc 60 will now be described. The toothed disc 60 is made up of a circular plate 65 and teeth 61 which extend from one face of the circular plate 65. The teeth 61 are arranged close to the edge of the circular plate 65. They extend from the circular plate 65 at roughly 90 degrees to the circular plate 65. As can be seen in FIG. 6a, there are eight teeth 61 on the toothed disc 60. When assembled as part of the new lamp post, the toothed disc 60 connects to both the cap 10 and tubular over-sleeve 31, as shown in FIG. 7. In particular, the longitudinal protrusions 91 defined by the interior surface of the tubular over-sleeve 31 fit into the radial gaps between the teeth 61.

Referring back to FIG. 6a, the teeth 61 are set in from the edge of the circular plate 65. Each tooth has an outer face 66 and an inner face 67. The radial distance between the outer face 66 of one tooth 61 and the outer face 66 of the tooth 61 which is opposite that first tooth is approximately equal to, or slightly less than, the interior diameter of the tubular over-sleeve 31. Thus, the teeth 61 fit inside the tubular over-sleeve 31. The longitudinal protrusions 91 in the tubular over-sleeve 31 are accommodated radially between the teeth 61. The diameter of the circular plate 65 is greater than the interior diameter of the tubular over-sleeve 31. Thus, the circular plate 65 can sit on top of the tubular over-sleeve 31.

The radial distance between the inner face 66 of one tooth 61 and the inner face 66 of the tooth 61 which is opposite that first tooth is approximately equal to, or slightly greater than, the exterior diameter of cap 10. Thus, the cap 10 fits inside the space between the teeth 61, just under the circular plate 65.

When the components are assembled, the cap 10 sits, as previously described, on the top of the lamp post base 1b and just below the toothed disc 60. The top 15 of the cap 10 sits just below the lower surface of the circular plate 65.

Turning now to FIG. 6b which shows a perspective view of a top of the toothed disc 60, the features of the upper surface 69 of the circular plate 65 will now be described. The circular plate 65 has eight bolt holes 64 through it. These bolt holes 64 are oriented parallel to the teeth 61. That is, the axes of the bolt holes 64 lie in planes perpendicular to the surface of the circular plate 65. The bolt holes are evenly radially spaced. The bolt holes 64 are close to the edge of the circular plate 65. The centre of each of the bolt holes 64 lies at the same radius from the centre of the circular plate 65 as do the teeth 61. The centre of each of the bolt holes 64 lies at the same radius from the centre of the circular plate as do the centres of the longitudinal grips 92 from the central axis of the tubular over-sleeve 91. As mentioned above, the four longitudinal grips 92 on the tubular over-sleeve 31 are evenly radially spaced. The eight bolt holes 64 through the circular plate 65 are also evenly radially spaced. Since the bolt holes 64 lie at the same radial distance from the centre of the circular plate 65 as do the longitudinal grips 92 from the central axis of the tubular over-sleeve 31, four of the bolt holes 64 align with the longitudinal grips 92 when the tubular over-sleeve 31 and toothed disc 60 are arranged coaxially.

When the components are assembled, a bolt is inserted into each of four of the bolt holes 64. In this embodiment, a bolt is inserted into every-other bolt hole 64. When the toothed disc 60 sits on top of the tubular over-sleeve 31, the position of the bolts through the bolt holes corresponds to the longitudinal grips 92 of the tubular over-sleeve 31. The toothed disc 60 can thereby be held in place on the top of the tubular over-sleeve 31. The bolts through the bolt holes 64 and into the longitudinal grips 91 of the tubular over-sleeve prevent the toothed disc 60 from rotating relative to the tubular over-sleeve 31.

The circular plate 65 also has a central hole 62. The central hole 62 is radially in the centre of the circular plate 65. When the toothed disc 60 is assembled with the other components described herein, the central hole 62 of the toothed disc 60 aligns with the central hole 17 of the cap 10. This allows any electrical wires from the existing lamp post base 1b to be drawn through the two central holes 17 and 62.

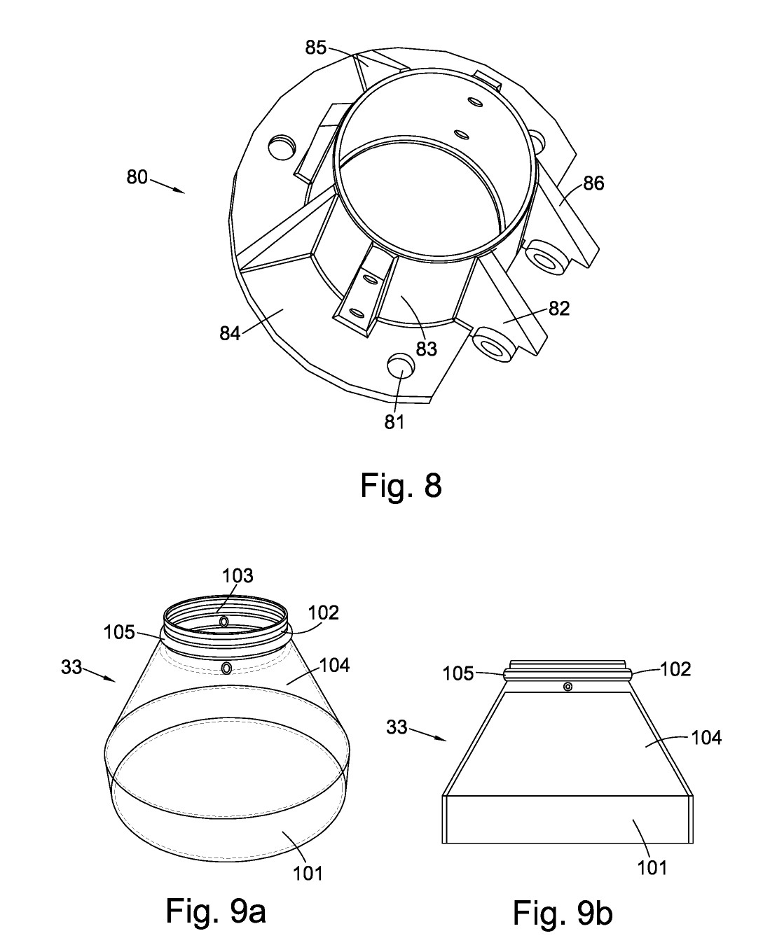

There is a hinge 63 on the upper surface 69 of the toothed disc 60. The hinge 63 takes the form of the barrel hinge. The axis of this hinge 63 is located in a plane parallel to a tangent of the circular plate 65. The hinge 63 is located towards one edge of the circular plate 65. The hinge 63 is set in from the edge of the circular plate 65. In use, the bracket 80 (introduced above with reference to FIG. 3, and described in more detail below with reference to FIG. 8) is coupled to the toothed disc 60 via this hinge 63.

The toothed disc 60 has a further three bolt holes 66 in addition to the eight bolt holes 64 described above. These bolt holes 66 are equidistant from the axis of the toothed disc 60 and from each other.

With reference now to FIG. 8, the bracket 80 will now be described. The bracket consists of a central collar 83, and a flange 84 extending radially outward from one axial end of this collar 83. The central collar 83 is tubular in shape. It is supported on the flange 84 by two buttresses 85. When viewed axially, the flange 84 is a disc with a section missing. The missing section is defined by a tangent to the collar 83, or, in other words, by the intersection of a cord with the circle defined by the edge of the flange 84. There is a hole in the centre of the flange 84 corresponding to the base of the tubular collar 83. The flange also has three bolt holes 81, radially spaced from one another. These bolt holes correspond in position to the bolt holes 66 in the toothed disc 60 described above when the toothed disc 60 and bracket 80 are axially aligned. In other words, the bolt holes 81 are positioned at the same radial distance from the central axis of the bracket 80 as the distance between the bolt holes 66 of the toothed disc 60 from the central axis of the toothed disc 60.

Two arms 86 extending from the collar 83 each support a barrel of a hinge 82. In use, the hinge 82 barrels fit between the barrels of the hinge on the toothed disc 60, on the same axis. When assembled, therefore, the bracket 80 is hinged relative to the toothed disc 60 by the insertion of a rod through the four barrels of the hinges 63 and 82 on the toothed disc 60 and bracket 80. The bracket 80 can be clamped to the toothed disc 60 by means of bolts inserted through the bolt holes 81 on the bracket 80 and the bolt holes 66 on the connector 60. This prevents the bracket 80 and toothed disc 60 from being displaced relative to one another.

With reference now to FIGS. 9a and 9b, the cover in the form of a conical lid 33 will now be described. As can be seen from these figures, the body of the conical lid 33 is a frustum of a cone. The conical lid 33 has a flange portion 101 extending around the base of the cone section 104. The flange portion 101 extends parallel to the axis of the conical lid 33. The inner diameter of the flange 101 of the conical lid 33 is slightly greater than the outer diameter of the tubular over-sleeve 31. At the top of the cone section 104, the conical lid 33 has a neck 102. This neck 102 extends generally parallel to the axis of the conical lid 33, but has a radial protrusion 105. This radial protrusion 105 accommodates a seal 103 in the interior of the neck 102 of the conical lid 33.

With reference to FIG. 3, the new lamp post 34 will now be described. The new lamp post 34 is a long tube. In other words, the new lamp post 34 is a hollow cylinder. It is formed from aluminium. The outer diameter of the new lamp post 34 is slightly less than the inner diameter of the neck 102 of the conical lid 33.

The assembly of the above-described components will now be described with particular reference to FIGS. 1 to 9b. When a decision has been made to replace the existing lamp post 1 with a new lamp post, the existing lamp post is cut off above the door (not shown) that gives access to its electrical connections. The cut-off section of the old lamp post that is left forms the lamp post base 1b described above. The tubular over-sleeve 31 is fitted over this lamp post base 1b. In this embodiment, the ground around the lamp post base 1b is dug out so that the tubular over-sleeve 31 can be planted in the ground around the lamp post base 1b. Once the tubular over-sleeve 31 has been fitted around the lamp post base 1b, this ground can be refilled with concrete to provide stability and support to the tubular over-sleeve 31. Next, the cap 10 is inserted into the tubular over-sleeve 31. The longitudinal protrusions 91 in the tubular over-sleeve 31 are aligned with the grooves 14 in the outer surface 11 of the cap 10. This allows the cap 10 to be held in place radially relative to the tubular over-sleeve 31. Since the cap 10 defines a cavity 16 which is octagonal in cross section, the wall 18 of the cap 10 sits around the lamp post base 1b, which is also octagonal in cross-section. The top 15 of the cap 10 sits on top of the lamp post base 1b. The hole 17 in the cap 10 aligns with a central hole in the lamp post base.

Next, the toothed disc 60 is placed on top of the cap 10. The longitudinal protrusions 91 of the tubular over-sleeve 31 align with the radial gaps between the teeth 61 of the toothed disc 60. The circular plate 65 of the toothed disc 60 sits on top of the cap 10, with its edges resting on the end of the tubular over-sleeve 31. The radial orientation of the toothed disc 60 may be selected to be in one of eight positions. This selection is performed by turning the toothed disc 60 by integer multiples of an eighth of a turn so that the spaces between its teeth 61 align with the longitudinal protrusions 91 of the tubular over-sleeve 31. Thus, the position of the hinge 63 of the toothed disc 60 relative to the tubular over-sleeve 31 can be selected. The choice of orientation of the hinge 63 of the toothed disc 60 may be based on considerations relating to the environment of the lamp post base 1b. As will be described below, the hinge 63 of the toothed disc 60, in conjunction with the hinge 82 of the bracket 80, allows the new lamp post 34 to be hinged relative to the lamp post base 1b. The radial direction in which the new lamp post 34 hinges relative to the lamp post base 1b can be selected depending on any obstacles present in the environment of the lamp post base 1b. For example, if the lamp post base 1b is close to a wall, it would not be desirable to have the new lamp post 34 be arranged to hinge towards that wall. Thus, an orientation with the hinge 63 of the toothed disc 60 away from that wall would be chosen in the situation. The orientation of the tubular over-sleeve 31 relative to the lamp post base 1b is determined by the position of the door in the lamp post base 1b. Without the cap 10, the orientation of the hinge 63 would therefore be predetermined.

Once the orientation of the toothed disc 60 has been selected and the toothed disc 60 has been fitted to the tubular over-sleeve 31, the bracket 80 is attached to the toothed disc 60. The bracket 80 is attached to the toothed disc 60 by the respective hinges 82, 63 of these two components. Specifically, the barrels of the hinge 82 of the bracket 80 are inserted between the barrels of the hinge 63 of the toothed disc 60, and a rod is fed through these barrels to allow the bracket 80 to pivot relative to the toothed disc 60.

Next, the conical lid 33 is threaded onto the new lamp post 34. The end of the main lamp post 34 is inserted through the neck 102 of the conical lid 33. The seal 103 in the radial protrusion 105 in the neck 102 of the conical lid 33 ensures that the conical lid 33 is tightly fitted to the new lamp post 34.

Then, the main lamp post 35, which has the conical lid 33 threaded onto it, is inserted into the collar 83 of the bracket 80. In a preparation step, the end of the new lamp post 34 has been swaged to produce a secure fit between the end of the new lamp post 34 and the collar 83 of the bracket 80. The insertion is performed while the bracket 80 is pivoted on its hinge relative to the toothed disc 60. In this way, this operation can be performed without the use of the crane, since the new lamp post 34 does not require to be inserted vertically into the collar 83 of the bracket 80.

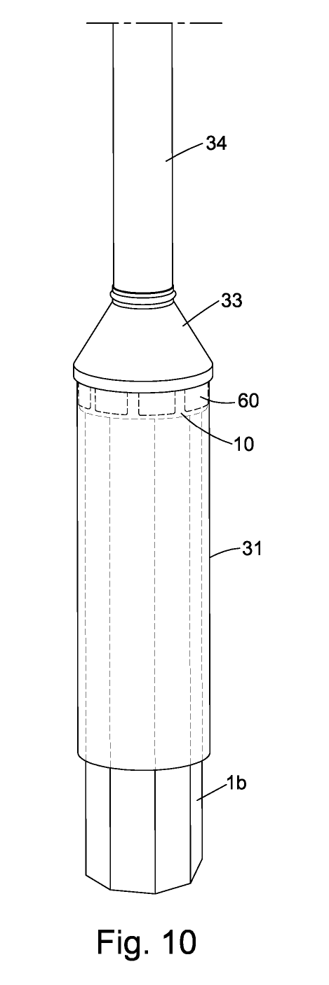

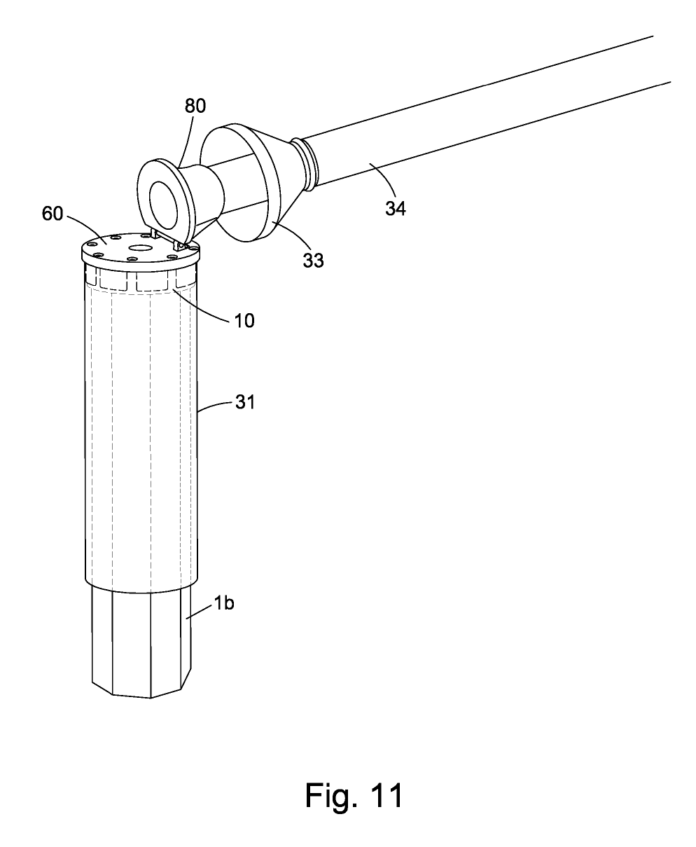

At this point all of the parts are connected to one another and the lamp post is in a lowered position as shown in FIG. 10. Next, the bracket 80 is pivoted on its hinge 83 relative to the toothed disc 60 so that the new lamp post 34, which is inserted into the collar 83 of the bracket 80, stands upright. If the orientation of a lantern on the main lamp post 35 is not as desired, the main lamp post 35 can be rotated in the collar 83 of the bracket 80, and then secured in this position with grub screws, not shown. To secure the main lamp post 35 in its vertical position, the bracket 80 is fixed to the toothed disc 60 via the three bolt holes 66, 81 in each of these components. Finally, the conical lid 33 is slid down the new lamp post 34 so that its flange 101 contacts the exterior of the tubular over-sleeve 31. This conceals the bracket 80, the toothed disc 60 and the cap 10. It also protects these components from rain. A fully assembled lamp post comprising these components is shown in FIG. 11.

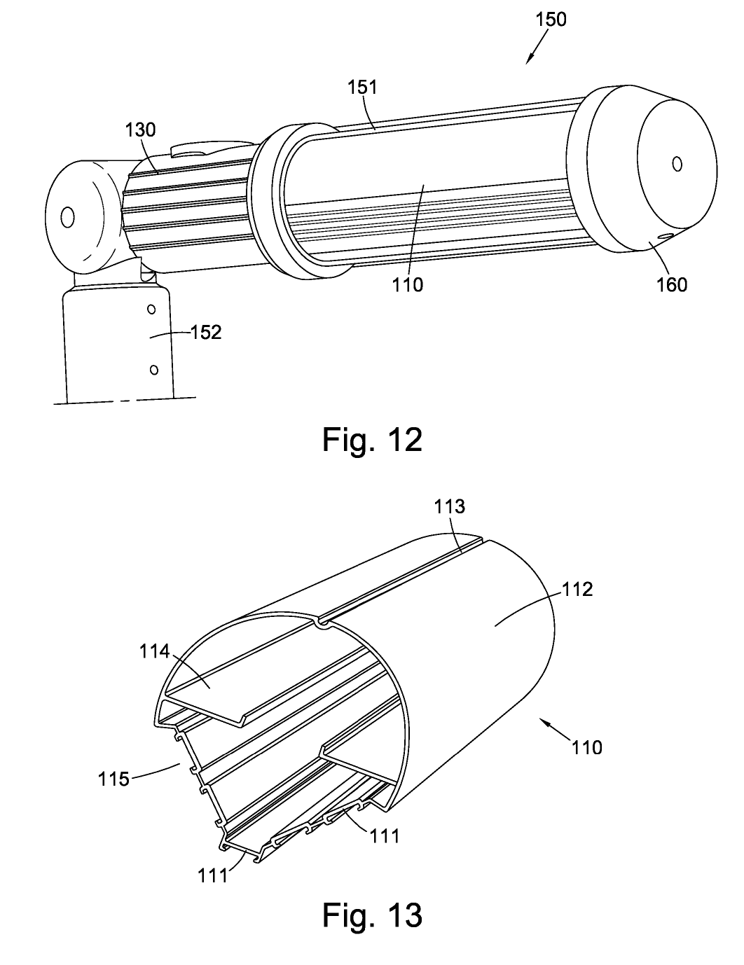

With reference to FIG. 12, a lamp which is mounted on the new lamp post 35 described above will now be described. It will be appreciated that in alternative arrangements the lamp shown in FIG. 12 may be mounted on lamp posts other than lamp post 35 described above or may be mounted using alternative means. In overview, the lamp, in the form of a street lamp lantern 150, is made up of: a lighting-device mount, or mount 110 on which strips of lighting elements are mounted, a lamp fitting, and a post fitting 152. The lamp fitting is in turn made up of: a support device in the form of a socket 130 in which the strips of lighting elements are connected, an enclosure in the form of a casing 151 that surrounds the mount, and an end-connector in the form of an end cap 160, which seals one end of the enclosure. The post fitting 152 connects to the top end of a lamp post (not shown). The socket 130 is attached to this post fitting 152. The mount 110 onto which up to four strips of lighting elements such as LEDs (not shown) are mounted is held in place by the socket 130. [Frank: do you have any drawings of the LED strips, or of the lamp with the LED strips?] The casing 151, also held in place by the socket 130, surrounds the mount 110. The end cap 160 fits onto the end of the casing 151 and mount 110. This structure provides many advantages, which will become apparent in the detailed description of each of these features set-out below.

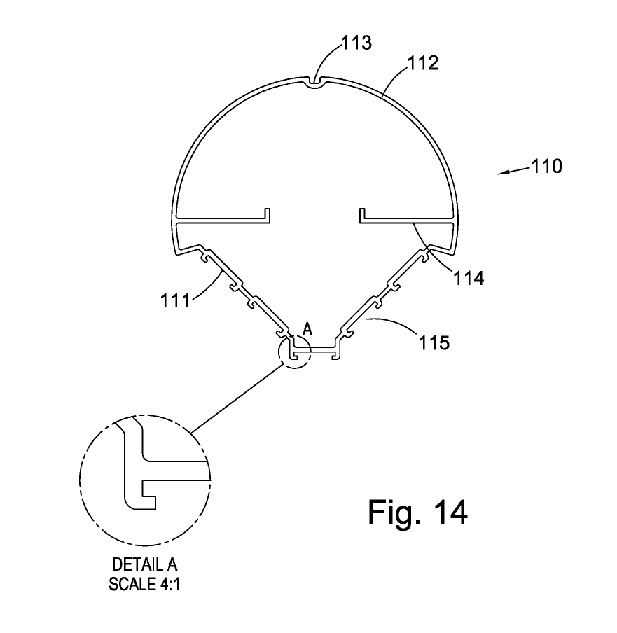

With reference now to FIGS. 13 and 14, the mount 110, which, when the lantern 150 is assembled, is housed within the casing 151 (not shown in these figures), will now be described. The mount 110 is made from extruded aluminium. It has the same cross-section along its length. This cross-section is shown in FIG. 12. Since the mount defines the length of the lantern 150, the structure of the mount means that it is very easy to make a lantern of any particular length just by varying the size of the mount. The mount 110 has a curved top surface 112. This top surface 112 is semi-circular in cross-section. There is a top groove 113 in the top surface 112. It runs along the length of the top surface 112. The groove is provided to enable a solar panel for at least partially powering the lantern 150 to be connected to the top surface 112 of the mount 110. The mount 110 also has two planar surfaces 115. Inner sides of each of the planar surfaces 115 join one another at a central point running along the length of the mount 110. In addition, outer sides of the planar surfaces 115 join a respective side of the top surface 112. These two planar surfaces 115 are at approximately 90 degrees to one another. When the mount 110 is arranged horizontally both of the two planar surfaces are approximately 45 degrees to horizontal.

Each of the two planar surfaces 115 defines two longitudinal grips 111. It will be appreciated that more or fewer such grips could be provided. These grips 111 are flat-bottomed grooves in the planar surfaces 115 with over-hanging lips. A further grip 111 is defined by the surface where the two planar surfaces 115 meet. Again, more of such grips could be provided at this position. There are therefore five grips 111 defined by the planar surfaces 115 of the mount 110. Each grip 111 can hold a strip of LED lights (not shown). Up to five strips of LED lights can therefore be supported by the mount 110. The mount 110 also has two inner supports 114. Each inner support 114 provides a shelf extending inwardly towards the axis of the mount 110 and at approximately 45 degrees to the planar surfaces 115. The shelves provide a support for electrical cables to run along the length of the mount 110 such that the electrical cables are kept away from the inside portion of the mount where the grips 111 are provided in order to reduce the effects of heat and electromagnetic interference caused by the LED lights on the electrical cables.

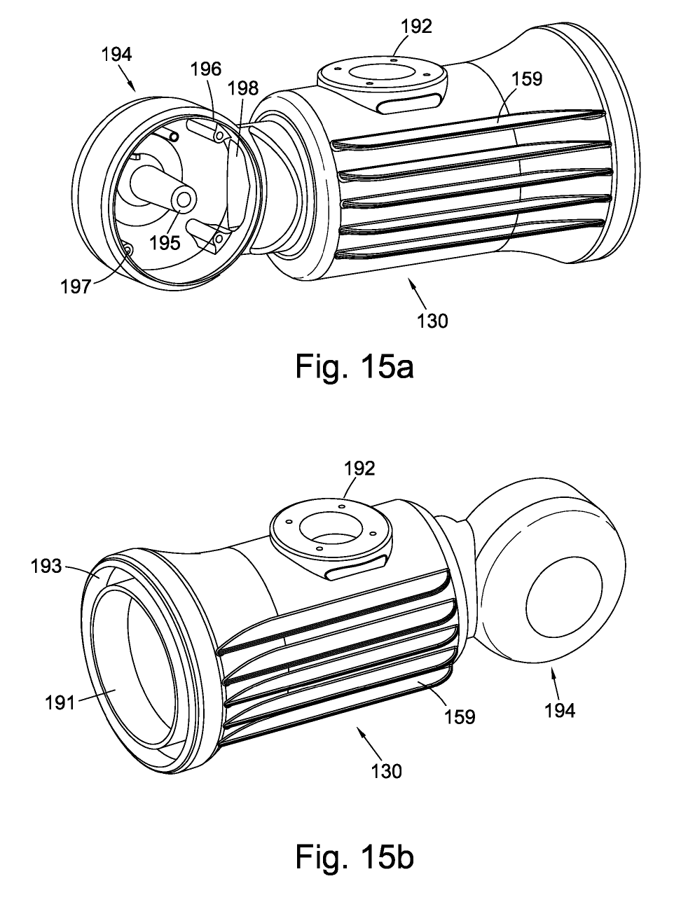

In the lantern 150, the mount 110 is held at one end by a socket 130. This socket 130 is shown in FIGS. 15a and 15b. The socket 130 has a tubular collar 191 at one end. The tubular collar 191 has a slightly greater inner radius than the outer radius of the mount 110. The tubular collar 191 therefore fits radially around an end of the mount 110, so that the socket 130 can support the mount 110.

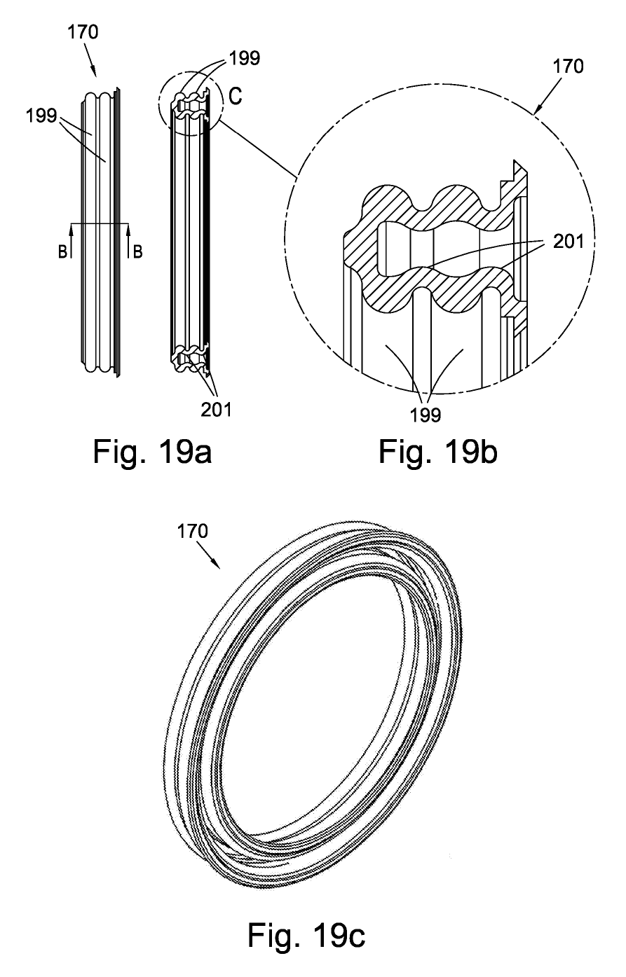

The socket 130 has a second collar, a casing collar 193, surrounding the tubular collar 191. When the lantern 150 is assembled, the casing 152 (not shown in FIGS. 15a and 15b) is held by this casing collar 193. When the lantern 150 is assembled, a gasket 170 is fitted into the casing collar 193 to secure the casing 152 in the casing collar 193. This gasket 170 will be described in more detail below, with reference to FIGS. 19a, 19b and 19c.

On one surface of the socket 130, there is a light-sensitive cell fitting 192. The surface on which the light-sensitive cell fitting 192 is located is the upper surface of the socket 130 when the socket 130 is in the assembled lantern 150. A light-sensitive cell (not shown) is installed in the light-sensitive cell fitting 192 to allow the lantern 150 to detect light conditions around the lantern 150. The lantern 150 can then be switched on or off according to these light conditions.

At the opposite end of the socket 130 to the tubular collar 191 and casing collar 193, the socket 130 has a connector 194. This connector 194 has an axis perpendicular to the axis of the collars. When the lantern 150 is assembled, the connector 194 connects to a corresponding part on the post fitting 152, the post fitting connector 137. It allows the socket 130, and hence the mount 110, which supports the LED lighting devices, to pivot relative to the post fitting 152. In use, this allows the direction of light cast by the LEDs to be selected.

The socket 130 has cooling fins 159 on its exterior surface. This socket 130 has ten cooling fins 159, five on each side. When the lantern 150 is assembled and in use, these cooling fins 159 dissipate heat from LEDs held in the mount 110. This is especially useful when there is a large number of LEDs in the mount.

The socket connector 194 is circular in cross-section. In shape, it is like a section of a tube, closed at one end. The socket connector 194 has a cable hole 198 in the wall between it and the main body of the socket 130. This allows electrical cables to be passed through the cable hole 198 and into the tubular collar 191 to provide power to LEDs mounted in the mount 110. The socket connector 194 has a central pin 195, parallel to its axis, which engages with a central pin 138 of a connector 137 on the lamp post fitting. The socket connector 194 has a lip 196 around its open edge which mates with the connector 137 on the lamp post fitting. Finally, it has screw fittings 197 in its interior which enable a ratchet ring 140 (not shown in FIGS. 19a and 19b) to be fixed to it.

With reference, now, to FIG. 16, the structure of the post fitting 152 will now be described. This fitting has a post collar 136. The post collar 136 is tubular in shape. This tube is open at one end so that the post collar 136 can therefore fit over the top end of a cylindrical lamp post. The post collar 136 is closed at its other end. The post fitting connector 137, referred to above, is joined to this closed end of the post collar 136. The post fitting connector 137 is of very similar construction to the socket connector 194. It differs, however, in that it does not have a lip 196. Instead, the lip 196 of the socket connector 194 mates with the open end of the post fitting connector 137 when the lantern 150 is assembled using these components. The post fitting connector 137 also differs from the socket connector 194 in that the post fitting connector 137 has a cable hole 139 in its base. This cable hole 139 extends parallel to the axis of the post collar 136 and goes through the wall of the post fitting connector 137 into the space defined by the walls of the post collar 136. When the lantern 150 is assembled on top of a lamp post (such as the one described above), electrical cables can be drawn through the post and through the cable hole 139 to supply electrical power to the lantern 150. The post fitting connector 137 also has a cam cleat 132, made up of two cams 131. One cam 131 is positioned on one side of the cable hole 139, and the other cam 131 is positioned on the opposite side of the cable hole 139. The cams 131 turn on pivots which extend parallel to the axis of the post collar connector 137. The cams 131 are loaded by a spring (not shown) such that they incline towards one another. The cam cleat 132 allows a cable to be drawn through the cable hole 139, and grips it in place. The bias of the cams 131 prevents the cable from slipping back.

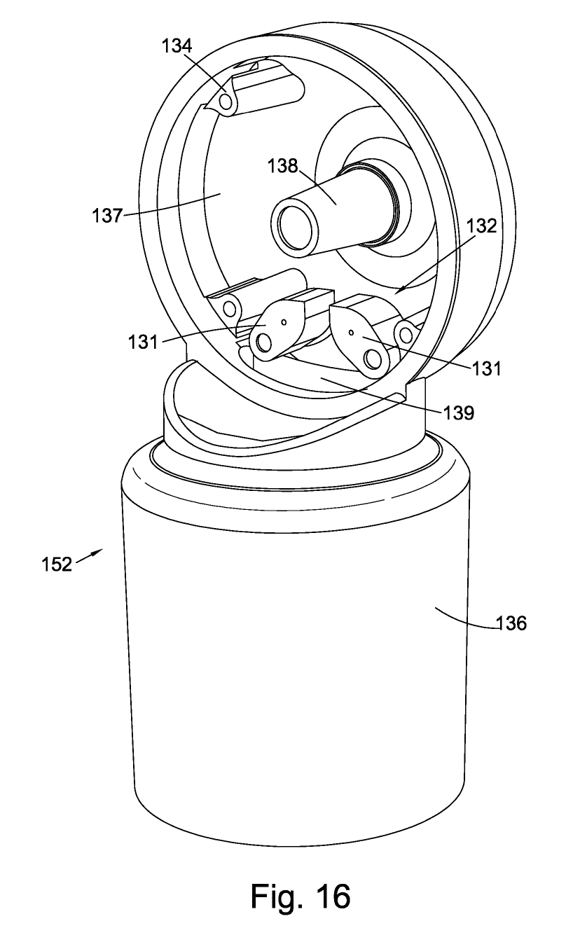

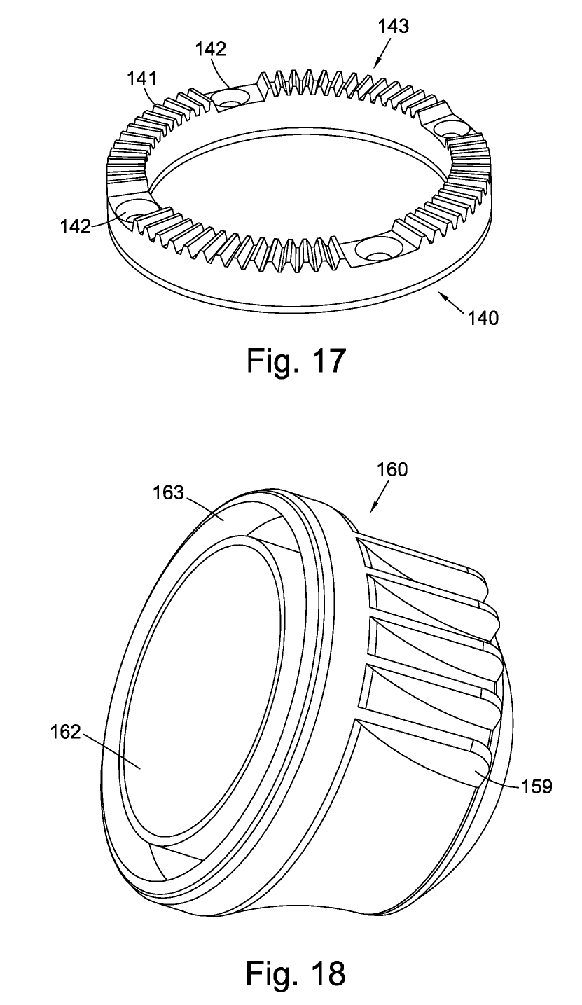

When the lantern 150 is assembled, a ratchet ring 140 is installed inside each of the post fitting connector 137 and the socket connector 194. There are therefore two ratchet rings 140. They are each the same as the other in construction. A ratchet ring 140 will now be described, with reference to FIG. 17. This ratchet ring 140 is annular in shape. It is rectangular in cross-section. Its surfaces parallel to its axis are smooth, as is one of its surfaces perpendicular to the axis. The remaining, top, surface 143, however, has teeth 141. These teeth 141 are closely spaced and extend radially across the top surface 143.

The teeth 141 are interrupted at four points by screw holes 142, which are evenly radially spaced about the ratchet ring 140. These screw holes 142 allow a ratchet ring 140 to be secured to each of the two connectors 137, 194 by the screw fixings 197 in these connectors. When the lantern is assembled, the teeth of the two ratchet rings 140 engage. The socket 130 can therefore be pivoted relative to the post fitting 152, but the ratchet rings 140 ensure it stays in place once its position has been selected.

With reference again to FIG. 12, the lantern 150 casing 151 will now be described. As mentioned above, when assembled, the casing 151 surrounds the mount 111 and is secured at one end by the socket 130. The casing 151 is a tube of transparent, self-cleaning plastic. In an alternative lantern, it could be made from glass. The fact that the casing 151 is tubular means that it is able to withstand greater loads than it could if it were differently-shaped. The fact that the casing 151 is made from self-cleaning plastic reduces the need to maintain the lantern 150 by cleaning it. The tubular shape also allows rain-water to run over the casing 151 when the lantern 150 is outdoors, thereby cleaning it to some extent.

With reference now to FIG. 18, the end-cap 160 will now be described. When the lantern 150 is assembled, the end-cap 160 is attached to the other end of the mount 110 and casing 151 than the socket 130. The end-cap 160 is shaped like a tube, closed at one end. It resembles the socket 130 in that it has a tubular collar 162 at its open end. Like the tubular collar 191 of the socket 130, the tubular collar 162 has an inner radius which is slightly greater than the outer radius of the mount 110. The tubular collar 162 of the end-cap 160 therefore fits radially around the opposite end of the mount 110 than the tubular collar 191 of the socket 130, so that the end-cap 160 closes off the, otherwise open, end of the mount 110. Again, like the socket 130, the end-cap 160 has a casing collar 163 radially outside the tubular collar 162. In the space between the tubular collar 162 and the casing collar 163, there is a gasket 170. This gasket 170 will be described below with reference to FIGS. 19a, 19b and 19c. When the lantern 150 is assembled, the casing 152 is held in the gasket 170 by the casing collar 163. The end-cap 160, like the socket 130, also has cooling fins 159 on its exterior surface to help dissipate hear from LEDs mounted in the mount 110 when the lantern 150 is assembled.

The end-cap 160 has a valve, not shown, in its closed end. This valve allows the casing 152 of the assembled lantern 150 to be filled with a gas, much as a bicycle tyre can be filled with air. The lantern 150 can be filled with argon gas, helping to keep the LEDs mounted in the mount 110 cooler than they would otherwise be.

The gasket 170, shown in FIGS. 19a, 19b and 19c, sits, when the lantern 150 is assembled, in the casing collar 163. It is the same in construction as the gasket 170 which sits in the casing collar 193 of the socket 130 when the lantern 150 is assembled. The gasket 170 helps to hold the casing 152 in place. The gasket 170 is formed of a flexible material, in this case rubber. The gasket 170 is annular in shape and roughly U-shaped in cross-section. It has two, outer, ribs 199 around its exterior circumference. These outer ribs 199 run parallel to one another. Two more, inner, ribs 201 run parallel to one another around the interior circumference of the gasket 170. These inner ribs 201 are offset relative to the outer ribs 199. In other words, in cross-section, the peaks of the inner ribs 201 are at positions in the interior of the gasket 170 corresponding to the positions on the exterior of the gasket 170 of the troughs between the outer ribs 199. The fact that the outer 199 and inner 201 ribs are offset relative to one another makes insertion of the casing 151 into the gasket 170 held by the casing collar 163 easier than if the inner 201 and outer 199 ribs were at corresponding positions on the interior and exterior of the gasket 170. This is especially useful when the casing collar 163 or casing 151 have dimensions differing slightly from their design dimensions, due to manufacturing variations. The gasket 170 can accommodate these differences. The inner 201 and outer ribs 199 produce increased pressure on the casing 150 by comparison to a similar gasket without ribs. This improves the seal between the casing collar 193 and casing 150. This helps to keep water out of the casing 150, protecting any electrical components within it. It also allows the casing 150 to hold any gases with which it is filled.

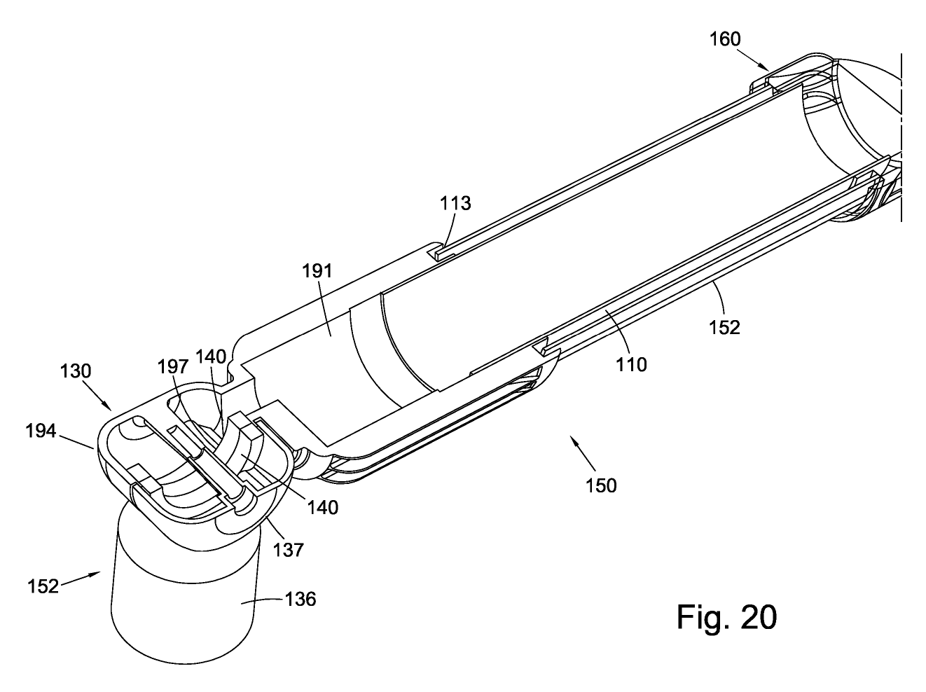

With reference now to FIG. 20, which shows a sectional view of the assembled lamp 150, the assembly of the lantern 150 using the above-described components will now be described. First, the end of the new lamp post 35 is inserted into the post collar 136 of the post fitting 152. The post fitting 152 thereby connects the lantern 150 to the new lamp post 35. Electrical cabling from the lamp post base 1b is run through the new lamp post 35 and through the cable hole 139 of the post fitting 152. It is prevented from slipping back by the cam cleat 132. A ratchet ring 140 is screwed to the screw holes 134 in the post fitting connector 137.

A ratchet ring 140 is also screwed to the screw fixings 197 of the in the socket connector 194. The electrical cabling (not shown) is passed through the cable hole 198 in the socket 130 and into the tubular collar 191 of the socket 130 to provide power for LEDs mounted in the mount 110. The socket 130 is then connected to the post fitting connector 137 via the socket connector 194. The lip 196 of the socket connector 194 fits just inside the open end of the post fitting connector 137. The teeth 141 of the two ratchets 140, screwed into the socket connector 194 and post fitting connector 137 engage with one another. The angle of the socket 130 can thereby be altered relative to the post fitting 153, allowing the light pattern cast by the lantern 150 in operation to be altered.

Strips of LEDs, five in this case, are slid into the longitudinal grips 111 on the mount 110. The mount 110 is then inserted into the tubular collar 191 of the socket 130 and electrically connected to the electrical cables.

Next, the casing 152 slotted over the mount 110 and inserted into the casing collar 193 on the socket 130. This holds the casing 152 in place around the mount 110.

Finally, the end-cap 160 is fitted over the ends of the mount 110 and casing 152 to seal the lantern 152.

It will be appreciated that the description above is of just one exemplary embodiment of the invention. Some alternative arrangements shall now be described in order to further exemplify some alternative aspects of the invention.

The casing might only have a single opening at one end that connects to the socket. In such an arrangement, the end-cap is not required. The casing might take the form of a hollow half-cylinder. In such an arrangement, it would not encase the whole of the lighting-device mount, but would cover the lighting devices supported by the mount.

The new post structure to be mounted over an existing post need not be a lamp post. For example, it could be a post with a camera mounted on it. Alternatively, it could be a post with a sign mounted on it. That sign could be a lit sign. The new post structure for supporting an electrical device could alternatively be a lighting bollard, that is, a bollard with a light mounted on it. The new post structure could be a charging point for electric vehicles. It could be a post with spot lights mounted on it, for example for illuminating the exterior of a building. In practice, the new post structure could be any post structure requiring an electricity supply.

The adaptor need not take the specific form described above. In alternative arrangements the adaptor is arranged to connect to an inner surface of the existing post via its outer surface. The new post may then connect to the adaptor from a connection to the inner surface of the adaptor. Alternatively, the adaptor may have an external surface that varies along its length so that the existing post and the new post connect to different parts of the external surface of the adaptor.

While the lamp post described herein is primarily described as being for use in connecting to an existing lamp post it will be appreciated that certain aspects described herein could be used for a completely new lamp post. For example, the arrangement described herein provides an advantage of allowing a hinged lamp post to have the hinging functionality offset with respect to a door for accessing the electrical components of the lamp post.

This advantage does not only relate to systems where the new lamp post is mounted over an existing lamp post.

It will be appreciated that in alternative arrangements the angles of the lighting device support elements may be different to that described above. Primarily, the angles are selected in order to provide a desired lighting pattern.

1. An adaptor for connecting a new post structure for supporting an electrical device to an existing post structure for supporting an electrical device, the adaptor comprising:
one or more first engaging features arranged, in use, to engage with at least part of the existing post structure; and
one or more second engaging features arranged, in use, to engage with at least part of the new post structure.

2. The adaptor according to claim 1, wherein at east one of the one or more first and second engaging features are surfaces of the adaptor.

3. The adaptor according to claim 1, wherein at least one of the one or more first and second engaging features are formed on surfaces of the adaptor.

4. The adaptor according to claim 1, wherein the one or more first engaging features form at least part of an interior surface of the adaptor and the one or more second engaging features form at least part of an exterior surface of the adaptor.

5. The adaptor according to claim 4, wherein the one or more first engaging features define an interior cross-section of the adaptor which is arranged to match the exterior cross-section of the existing post structure.

6. The adaptor according to claim 4, wherein the one or more second engaging features are arranged to connect to complementary engaging features of the new post structure.

7. The adaptor according to claim 6, wherein the one or more second engaging features are longitudinal indentations arranged to engage with longitudinal protrusions on an interior surface of the new post structure.

8. The adaptor according to claim 1, wherein the adaptor comprises a stopper arranged such that, in use, when the adaptor is fitted to the old post structure, the adaptor sits on the top of the old post structure with the stopper preventing the adaptor moving down the old post structure.

9. The adaptor according to claim 1, wherein the adaptor defines an axial hole through which electrical cables are able to pass.

10. The adaptor according to claim 1, wherein the adaptor is made of high-density foam.

11. The adaptor according to claim 1, comprising a plurality of alternative one or more first engaging features each arranged for connecting to a different type of existing post structure.

12. The adaptor according to claim 11, wherein a first of the plurality of alternative one or more first engaging features is removably connectable to a second of the one or more first engaging features such that, in use, when the first of the one or more first engaging features is connected to the second of the one or more first engaging features the adaptor is arranged to connect to the existing post structure via the first engaging features, and when the first of the one or more first engaging features is not connected to the second of the one or more first engaging features the adaptor is arranged to connect to the existing post structure via the second of the one or more first engaging features.

13. The adaptor according to claim 1, wherein the existing and new post structures are lamp post structures.

14. (canceled)

15. A connection structure for forming part of a post structure for supporting an electrical device, the connection structure comprising:
a first connector arranged to connect to a base portion of a post structure; and
a second connector arranged to connect to a supporting shaft of the post structure for supporting an electrical device, the second connector providing for a hinged connection between the connection structure and the supporting shaft, the hinged connection defining an axis of rotation;
wherein the connection structure is arranged to provide a plurality of different positional relationships between the position of the base portion and the position of the axis of rotation of the hinged connection.

16. The connection structure according to claim 15, wherein the first connector is arranged to connect to a base portion of a post structure having an opening for accessing electrical components inside the existing post structure; and
the connection structure is arranged to provide a plurality of different positional relationships between the position of the opening in the base portion and the position of the axis of rotation of the hinged connection.

17. The connection structure according to claim 15, wherein the second connector provides a finite number of positions for the base structure to connect.

18. The connection structure according to claim 17, wherein the finite number of positions are defined by a number of teeth.

19. The connection structure according to claim 15, wherein the first and second connectors are formed of one piece.

20. The connection structure according to claim 15, further comprising a connection element for connecting the first and second connectors.

21. The connection structure according to claim 15, further comprising a third connector arranged to connect the post structure to an existing post structure.

22. The connection structure according to claim 21, wherein the third connector is the adaptor of claim 1.

23. A lamp post comprising:
an existing lamp post structure for supporting an electrical device;
a new lamp post structure for supporting an electrical device;
an adaptor for connecting the new lamp post structure to the existing lamp post structure, the adaptor comprising:
one or more first engaging features arranged, in use, to engage with at least part of the existing post structure; and
one or more second engaging features arranged, in use, to engage with at least part of the new post structure.

24-43. (canceled)
